(19) United States
(12) Patent Application Publication
(10) Pub. No.: US 2015/0192990 A1
(43) Pub. Date: Jul. 9, 2015

(54) Display control method, apparatus, and terminal

(71) Applicant: ZTE Corporation, Shenzhen, Guangdong (CN)

(72) Inventor: Wei Qiang, Shenzhen (CN)

(21) Appl. No.: 14/421,067

(22) PCT Filed: Jun. 19, 2013
(86) PCT No.: PCT/CN2013/077509

§ 371 Date: Feb. 11, 2015

(30) Foreign Application Priority Data
Aug. 24, 2012 (CN) 201210305149.1

(51) Int. Cl. G06F 3/01; G06K 9/00

(52) U.S. Cl. CPC G06F 3/012; G06K 9/00248; G06K 9/00234

(57) ABSTRACT

In order to solve a problem that current terminal display control techniques are based on manual operations, the present disclosure provides a display control method, device and terminal. The device includes an acquisition module configured to acquire periodically a facial image of a user, a processing module configured to calculate coordinates of a reference object according to the facial image and compare the coordinates of the reference object with preset coordinates, and an execution module configured to execute an operation according to a processing result; the terminal includes a sensing device configured to sense a facial image of a user, a display device configured to display content and the display control device provided by the present present disclosure, wherein the display control device is configured to acquire periodically the facial image of the user through the sensing device, calculate the coordinates of the reference object according to the facial image; and control content display of the display device according to the coordinates of the reference object and the preset coordinates. With the implementation of the present disclosure, the user can implement control of content displayed by a terminal using only facial actions rather than a keyboard, a mouse or a touch screen, thus freeing both hands of the user and enhancing user experiences.

### TECHNICAL FIELD

The present disclosure relates to the field of terminal display, and in particular to a display control method, device and terminal.

### BACKGROUND

With the popularity of mobile terminals such as mobile phones and tablet computers, various additional functions of mobile terminals are increasing, for example devices such as cameras and touch screens; existing approaches for a user of a mobile terminal to control display of a screen (for example display of an electronic book, a webpage and an image) mainly include control of content displays of terminal devices through a keyboard, a mouse or a touch screen, for example page up/down or page left/right, zoom in/out of texts or images and the like.

The approaches of controlling display of a terminal through a keyboard, a mouse or a touch screen all have an apparent feature, i.e. a user is required to use his/her finger(s) to perform a click operation or a gesture control; however, in some special cases (for example during a meal), the user cannot perform a click operation since his/her hands are fully occupied, furthermore, since an operation on the touch screen is a contact operation, many operations thereon are readily misjudged, for example an unexpected single click during a page down/up operation is considered as an operation of confirmation, cancellation or backspace.

Therefore, for those skilled in the art, it is a problem demanding prompt solution to provide a totally new display control method based on the prior art so as to free both hands of a user.

### SUMMARY

In order to solve a problem that current display control techniques must depend on manual operations, the present disclosure provides a display control method, device and terminal.

In order to accomplish objectives of the present disclosure, the present disclosure provides a display control method, device and terminal that control terminal display based on facial movements; in an embodiment, the display control method provided by the present disclosure includes steps of:

a facial image of a user is periodically acquired;

coordinates of a reference object are calculated according to the facial image; and

an operation is performed according to the coordinates of the reference object and preset coordinates.

Preferably, in the above embodiment the reference object may be any one point or multiple points in the facial image; the preset coordinates may be spatial coordinates of the reference object when the user reads normally currently-displayed content.

Preferably, in the above embodiment the step of performing an operation according to the coordinates of the reference object and preset coordinates may specifically include two implementation ways:

a motion vector of the reference object is calculated according to the coordinates of the reference object and the preset coordinates, and the operation is performed according to a change of the motion vector of the reference object within a preset period of time; or

a spatial position of the reference object is determined according to the coordinates of the reference object and the preset coordinates;

the operation is performed according to a change of the spatial position of the reference object within a preset period of time.

Preferably, in all above embodiments, when the reference object is one or two center points of pupils of the user in the facial image, the calculating coordinates of the reference object according to the facial image may include steps of:

an RGB component image of the facial image is acquired, and a red component image is selected;

a reverse color diagram of the red component image is obtained by subtracting 255 from component values of respective points of the red component image;

coordinates of peak values in a X axis direction and in a Y axis direction are acquired by performing accumulation on the reverse color diagram in the X axis direction and in the Y axis direction respectively; and

the coordinates of the reference object are determined according to the coordinates of the peak values.

The present disclosure also provides a display control device based on a facial image, and in an embodiment the display control device may include an acquisition module, a processing module and an execution module, wherein

the acquisition module is configured to acquire periodically a facial image of a user;

the processing module is configured to calculate coordinates of a reference object according to the facial image, compare the coordinates of the reference object with preset coordinates and output a processing result to the execution module; and

the execution module is configured to execute an operation according to the processing result.

Moreover, in order to apply the display control techniques provided by the present disclosure into practical application, the present disclosure further provides a display control terminal; in an embodiment, the display control terminal may include a sensing device, a display device and the display control device provided by the present disclosure; the display control device is configured to acquire periodically the facial image of the user through the sensing device, calculate the coordinates of the reference object according to the facial image, and control content display of the display device according to the coordinates of the reference object and the preset coordinates.

Embodiments of the present disclosure provide a technique for controlling display of a terminal based on facial actions of a user, firstly, the technique performs display control based on facial images of a user, thus freeing thoroughly both hands of the user; secondly, the technique performs display control based on relative coordinates of a reference object on the user's face, and the user can set as required the reference object, thus making it possible to provide the user with diversified individualized selections; next, the operation principle of the technique is simple, the display of the terminal can be controlled only according to changes of the reference object in spatial position or in motion vector, thus having low requirements on the terminal's hardwares; finally, the technique is convenient and efficient since it can perform control based on a change of the position of the user's pupil when the user is reading; to sum up, with the implementation of the present disclosure, the user can implement control of content displayed by a terminal using only facial actions rather than a keyboard, a mouse or a touch screen, thus enhancing user experiences.

### BRIEF DESCRIPTION OF THE DRAWINGS

FIG. 1 is a schematic structural diagram of a display control terminal 1 according to an embodiment of the present disclosure;

FIG. 2 is a schematic structural diagram of a display control device 12 according to an embodiment of the present disclosure;

FIG. 3 is a schematic structural diagram of a processing module 122 of a display control device 12 according to a preferred embodiment of the present disclosure;

FIG. 4 is a flow chart of a display control method according to an embodiment of the present disclosure;

FIG. 5a is a flow chart of a method for positioning a reference object according to an embodiment of the present disclosure;

FIG. 5b is a schematic diagram of a facial image according to an embodiment of the present disclosure;

FIG. 6a is a flow chart of a display control method according to an embodiment of the present disclosure;

FIG. 6b is a schematic diagram showing a reference object's change in spatial position according to an embodiment of the present disclosure;

FIG. 6c is a schematic diagram showing a reference object's change in spatial position according to an embodiment of the present disclosure;

FIG. 6d is a schematic diagram showing a reference object's change in spatial position according to an embodiment of the present disclosure;

FIG. 7a is a flow chart of a display control method according to an embodiment of the present disclosure;

FIG. 7b is a schematic diagram showing a reference object's change in motion vector according to an embodiment of the present disclosure;

FIG. 7c is a schematic diagram showing a reference object's change in motion vector according to an embodiment of the present disclosure;

FIG. 7d is a schematic diagram showing a reference object's change in motion vector according to an embodiment of the present disclosure;

FIG. 7e is a schematic diagram showing a reference object's change in motion vector according to an embodiment of the present disclosure;

FIG. 7f is a schematic diagram showing a reference object's change in motion vector according to an embodiment of the present disclosure; and

FIG. 7g is a schematic diagram showing a reference object's change in motion vector according to an embodiment of the present disclosure.

### DETAILED DESCRIPTION

The present disclosure will be further elaborated below through specific embodiments in combination with accompanying drawings.

In order to solve the problem that current display control techniques must depend on manual operations, the present disclosure provides a totally new display control technique that controls display of a terminal device through monitoring in real time, by the terminal device, actions of a user's face (or head) and calculating a change of a reference object on the user's face in position between current coordinates and set coordinates or in motion vector.

FIG. 1 is a schematic structural diagram of a display control terminal 1 according to an embodiment of the present disclosure.

It can be seen from FIG. 1 that according to an embodiment a display control terminal 1 provided by the present disclosure includes: a sensing device 11 configured to sense actions of a user's face (or head), a display device 13 configured to display content and a display control device 12 configured to control content displayed by the display device; the display control device 12 acquires a facial image of the user through the sensing device 11, and controls display of the display device 13 after a series of processing (elaborated thereinafter).

In the above embodiment, the sensing device 11 includes but is not limited to a camera, an infrared sensing device and other sensing devices based on other senses; the display device 13 includes but is not limited to a screen of a mobile phone, a display of a computer, a screen of a projector or an indoor/outdoor LED display.

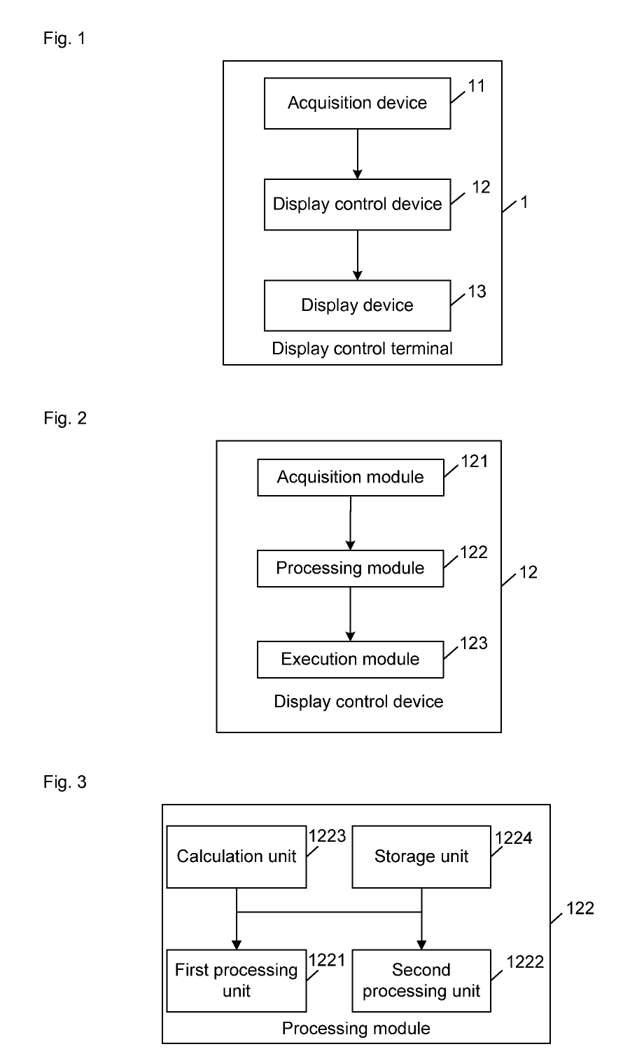

FIG. 2 is a schematic structural diagram of the display control device 12 in the display control terminal 1 as shown in FIG. 1.

It can be seen from FIG. 12 that according to an embodiment the display control device 12 included in the display control terminal 1 according to the above embodiment, includes an acquisition module 121, a processing module 122 and an execution module 123, wherein

the acquisition module 121 is configured to acquire periodically a facial image of a user and transmit acquired facial image to the processing module 122;

the processing module 122 is configured to calculate coordinates of a reference object according to the facial image, compare the coordinates of the reference object with preset coordinates and output a processing result to the execution module 123; and

the execution module 123 is configured to execute an operation according to the processing result transmitted by the processing module 122.

In the above embodiment, the acquisition module 121 acquires the facial image of the user through the sensing device 11 of the display control terminal 1; the execution module 123 is then used to control display of the display device 13 of the display control terminal 1.

In an embodiment, the reference object mentioned in the above embodiment may be any point of the facial image, for example any one pupil, apex of nose or even a marking point on a user's face can be acceptable; the preset coordinates are spatial coordinates of a selected reference object when the user reads normally currently-displayed content, it should be noted that the spatial coordinates of the reference object may be coordinates of only a point when the terminal device outputs through a small display and the spatial coordinates of the reference object are a range of coordinates when the terminal device outputs through a medium or large display, however, the type of the spatial coordinates of the reference object will not affect implementation of the present disclosure.

FIG. 3 is a schematic structural diagram of a processing module 122 of the display control device 12 as shown in FIG. 2.

It can be seen from FIG. 3 that in a preferred embodiment of the present disclosure, the processing module 122 of the display control device 12 as shown in FIG. 2 may include a first processing unit 1221, a second processing unit 1222, a calculation unit 1223 and a storage unit 1224, wherein

the first processing unit 1221 is configured to calculate a motion vector of the reference object according to the coordinates of the reference object and the preset coordinates, and output a processing result according to a change of the reference object in motion vector within a preset period of time;

the second processing unit 1222 is configured to calculate a spatial position of the reference object according to the coordinates of the reference object and the preset coordinates, and output a processing result according to a change of the reference object in spatial position within a preset period of time;

the calculation unit 1223 is configured to, when the reference object is one or two center points of pupils of the user in the facial image, acquire an RGB component image of the facial image, select a red component image, obtain a reverse color diagram of the red component image by subtracting 255 from component values of respective points of the red component image, acquire coordinates of peak values in a X axis direction and in a Y axis direction by performing accumulation on the reverse color diagram in the X axis direction and in the Y axis direction respectively, and determine the coordinates of the reference object according to the coordinates of the peak values; certainly, the calculation unit 1223 is mainly used to implement a function of positioning an reference object and it can implement positioning of the reference object through other positioning ways.

the storage unit 1224 is configured to store spatial coordinates of a point or moving range of spatial coordinates of the reference object when the user reads normally currently-displayed content of the terminal device; certainly, it can also configured to store work logs of the display control device 12 so as to facilitate the user to perform operations such as calibration; moreover, when the calculation unit 1223 can implement a function of storing data in a flash memory way, the function of the storage unit 1224 can be implemented by the calculation unit 1223.

In the above embodiment, the first processing unit 1221 and the second processing unit 1222 don't necessarily exist simultaneously, either of them can process the coordinates of the reference object and the preset coordinates, and the two processing units are based on two different data processing mechanisms.

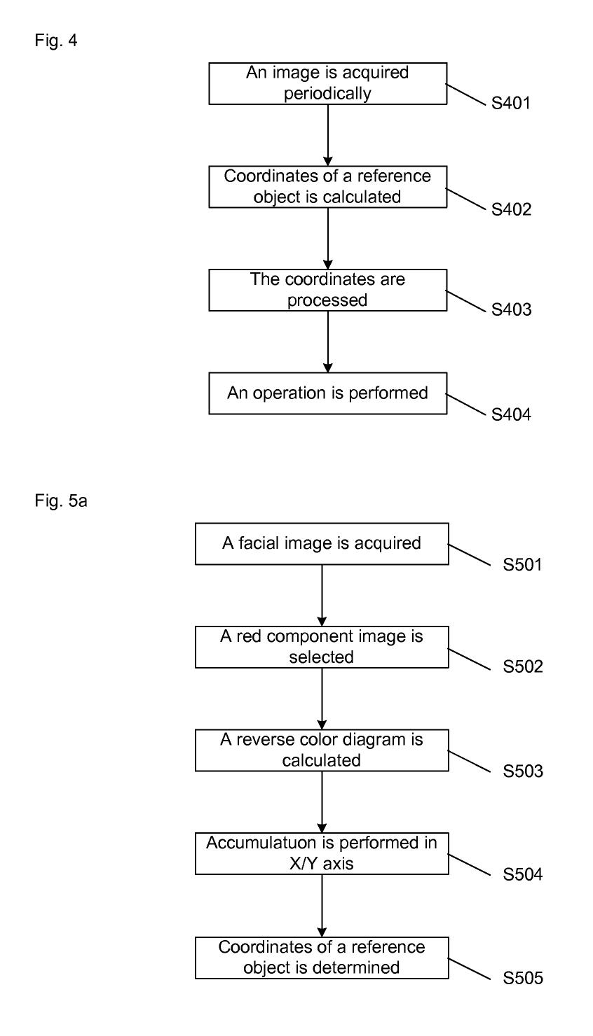

FIG. 4 is a flow chart of a display control method using the display control terminal 1 as shown in FIG. 1 according to an embodiment of the present disclosure.

It can be seen from FIG. 4 that in an embodiment, the display control method provided by the present disclosure includes the following steps:

S401, a facial image of a user is periodically acquired;

S402, coordinates of a reference object are calculated according to the facial image; and

S403, the coordinates of the reference object and preset coordinates are processed;

S404, an operation is executed according to a processing result.

In an embodiment, the reference object relating to the display control method as shown in FIG. 4 is any one point or multiple points in the facial image; the preset coordinates are spatial coordinates of the reference object when the user reads normally currently-displayed content.

In an embodiment, step S403 of the display control method as shown in FIG. 4 can be implemented in two ways, with their respective steps including:

a motion vector of the reference object is calculated according to the coordinates of the reference object and the preset coordinates;

an operation is performed according to a change of the motion vector of the reference object within a preset period of time;

or

a spatial position of the reference object is determined according to the coordinates of the reference object and the preset coordinates;

an operation is performed according to a change of the spatial position of the reference object within a preset period of time.

In an embodiment, when the reference object set by a user is a pupil of the user, implementation of step S402 of the display control method as shown in FIG. 4 includes:

an RGB component image of the facial image is acquired, and a red component image is selected;

a reverse color diagram of the red component image is obtained by subtracting 255 from component values of respective points of the red component image;

coordinates of peak values in a X axis direction and in a Y axis direction are acquired by performing accumulation on the reverse color diagram in the X axis direction and in the Y axis direction respectively; and

the coordinates of the reference object are determined according to the coordinates of the peak values.

In order to better describe the display control technique provided by the present disclosure, the present disclosure will be further elaborated in below embodiments in combination with daily life.

Implementation of the present disclosure mainly includes two aspects: a method for selecting and positioning a reference object in a facial image and a method for analyzing and controlling facial actions, and the two aspects are respectively described as follows.

The method for selecting and positioning a reference object in a facial image:

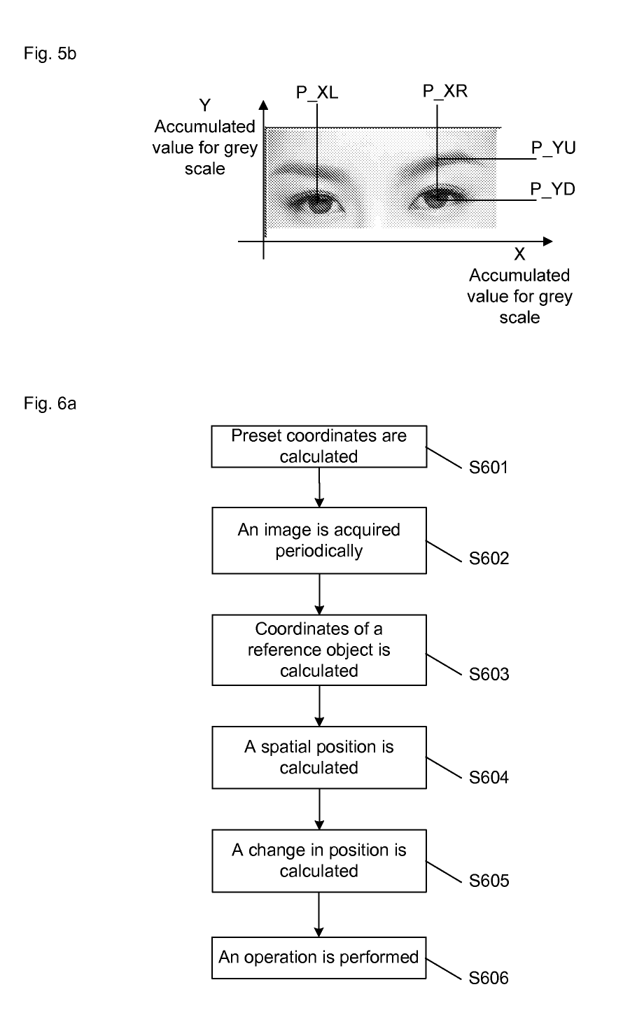

FIG. 5a is a flow chart of a method for positioning a reference object according to an embodiment of the present disclosure; FIG. 5b is schematic diagram of a facial image in embodiment of the present disclosure.

When the reference object is selected, the user is provided with individualized selections as required (marking points such as apex of nose or middle point between eyebrows), the user can certainly use a default configuration, and a default reference object is a middle point of a user's pupil.

The display control technique provided by the present disclosure is described below with reference to an embodiment in which assumptions are made as below: the user is of yellow race with yellow skin and black eyes, the sensing device of the display control terminal is a camera, the display device of the display control terminal is the display of a mobile phone, the user uses a default reference object of the display control terminal; then it can be seen from FIG. 5a that in an embodiment the method for positioning the reference object includes the following steps:

S501, a facial image of a user is acquired using a camera;

a facial image as shown in FIG. 5b is obtained by adjusting appropriately the position of the camera;

S502, a red component image (R_img) in an RGB color image of a current facial image of the user is selected as data to be processed;

since the RGB ratio for a person of yellow race with yellow skin (flesh color) is R-255: G-204: B-102, and the RGB ratio for the pupil center of a black eye is R-0: G-0:B-0, it can be seen that the color difference for red is most prominent, thus the red component is selected for calculation since it involves minimum errors, other color components can certainly be selected for calculation and the detailed description thereof will be omitted.

S503, a red component reverse color diagram R_R_img is obtained by subtracting 255 from the red component image R_img;

then pixel data in most of the facial image are 0, and the data of the pupil center (and eyebrows) is 255;

S504, accumulation is performed on the red component reverse color diagram in the X axis direction and in the Y axis direction respectively;

as shown in FIG. 5b, the accumulation in the X axis direction gets two peaks P_XL and P_XR which are centers of left and right pupils respectively, and the accumulation in Y axis direction also gets two peaks P_YU and P_YD which are centers of one eyebrow and one pupil;

S505, the coordinates of the reference object are determined;

Interferences from the eyebrow (P_YU) are eliminated (since the eyebrow is permanently above the eye), thus only the peak P_YD in Y axis direction is retained, then the coordinates of centers of the user's left/right pupil can be determined, then one pupil selected by the user or predefined by the system is regarded as the reference object and the coordinates of the reference object are recorded.

For users having combinations of other skin colors and eye colors, when the method for positioning a reference object as shown in FIG. 5a is used, the selection of which component image in an RGB color image of a user's facial image that is processed can be determined according to a pre-acquired facial image of a user and an RGB color look-up table (that can be downloaded via http://www.1141a.com/other/rgb.htm); those skilled in the art can readily implement the selection, thus the selection process will not be described herein.

It should be noted that the positioning method as shown in FIG. 5a can be implemented by other ways for positioning a reference object, such as spatial coordinate positioning, polar coordinate positioning and infrared positioning.

The method for analyzing and controlling facial actions:

Actions for several daily operations of a user are predetermined: moving of display content is implemented through slightly turning user's head up/down or to the left/right, for example, when a user wants to read content on a next page of the currently-displayed page, the user only needs to slightly lower his/her head and act as if he/she tries to look at the bottom (beyond the visual field) of the display; zooming in/out of the display content is implementing by decreasing/increasing a distance between the user's face and the display, for example, when texts are desired to be zoomed in, the user performs an action to slightly approach the display; a confirmation operation is implemented by nodding; and a cancellation operation is performed by heading shaking. Certainly, the display control terminal according to the present disclosure also supports actions defined by the user, for example operations such as close.

The display control technique provided by the present disclosure is described below with reference to an embodiment in which assumptions are made as below: coordinates of a reference object are 3D spatial coordinates, preset coordinates are moving range of spatial coordinates of the reference object when the user reads normally currently-displayed content of the terminal device, and operations include paging up/down/left/right (moving), zooming in/out, conformation and cancellation.

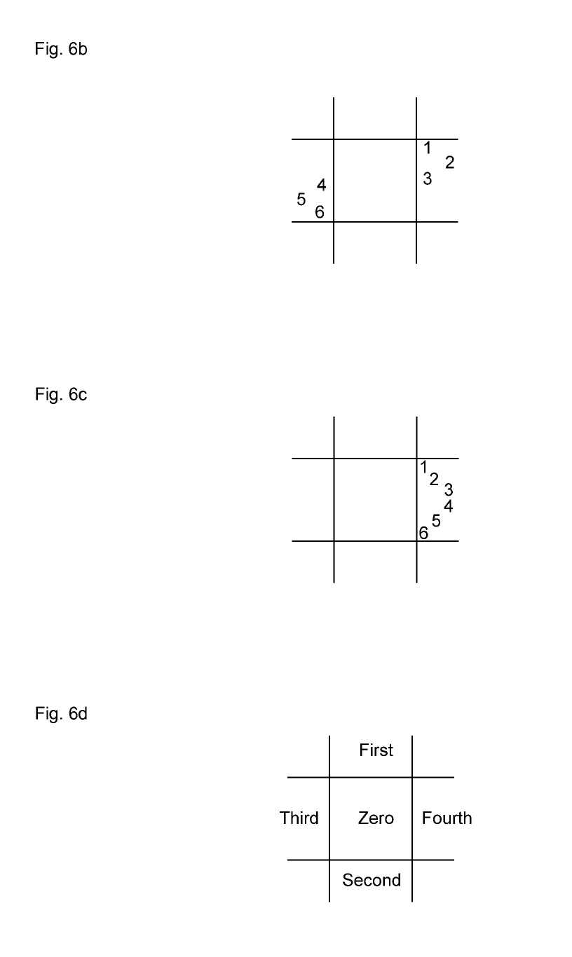

FIG. 6a is a flow chart of a display control method according to an embodiment of the present disclosure.

It can be seen from FIG. 6a that in an embodiment, the display control method provided by the present disclosure includes the following steps:

S601, preset coordinates are calculated and recorded;

the method for positioning a reference object as shown in FIG. 5a is used to calculate moving range of spatial coordinates of the reference object when the user reads normally currently-displayed content of the terminal device;

S602, a facial image of a user is periodically acquired;

since each camera device has an acquisition period, herein the period for acquiring facial images of a user is by default the acquisition period of the camera device;

S603, coordinates of a reference object are calculated;

the method for positioning a reference object as shown in FIG. 5a is used to calculate spatial coordinates of the reference object in the current facial image;

S604, a spatial position of the reference object is determined;

the current spatial position of the reference object is determined according to an obtained coordinates of the reference object calculated in step S603;

S605, a change of the spatial position of the reference object within a preset period of time is calculated;

the duration of the preset period of time is an execution time T set by the user to perform nodding or head shaking actions, when the user doesn't set the duration of the preset period of time, the duration of the preset period of time is a system default duration (an average period of time of nodding or head shaking obtained through statistics), and the starting instant is a time at which the spatial position of the reference object exceeds the preset coordinates;

for example the acquisition period of the terminal device is t and the execution time set by the user (or by default) to perform nodding or head shaking actions is T, then from the time at which the spatial position of the reference object exceeds a preset range of coordinates, changes of the reference object in spatial position within n acquisition periods are recorded and display is controlled according to the changes, wherein n=T/t; FIG. 6b and FIG. 6c are examples of the changes in spatial position;

S606, an operation is performed according to the change obtained in step S605;

the operation includes paging up/down/left/right or moving, zooming in/out, confirmation and cancellation.

In the above embodiment, the changes of the reference object in spatial position obtained in step S605 can be a change curve chart; it is assumed that the duration of the preset period of time is 6 acquisition periods; in the period of time, the change curve chart of the reference object in spatial position is shown in FIG. 6b and FIG. 6c respectively, wherein the change in spatial position as shown in FIG. 6b represents head shaking (i.e., cancellation operation), the change in spatial position as shown in FIG. 6c represents an operation of paging right; in FIGS. 6b and 6c, numbers 1, 2, 3, 4, 5, 6 represent respectively positions of the reference object in the facial image of the corresponding user.

The present disclosure is described according to FIG. 6d in order to describe more intuitively operations performed when the display control device detects changes of the reference object in spatial position, and in the preset period of time, if

the reference object keeps moving in a first region, it represents paging up;

the reference object keeps moving in a second region, it represents paging down;

the reference object keeps moving in a third region, it represents paging left;

the reference object keeps moving in a fourth region, it represents paging right;

the reference object moves within the first, zero and second regions back and forth, it represents a nodding operation;

the reference object moves within the third, zero and fourth regions back and forth, it represents a head shaking operation;

In the embodiment, only cases in which the reference object moves on a plane parallel to the display plane are provided, in other embodiments, the reference object may also move on planes perpendicular to the display plane, then 3D coordinates can be used to calculate spatial positions of the reference object and change of the reference object in spatial position, for example the X axis represents a direction from left to right, the Y axis represents a direction from up to bottom ad the Z axis represents a direction from front to back; when the object moves in the Z axis direction, a decrease in Z-axis coordinates represents that the reference object is approaching the display, then the display content is zoomed in , otherwise, the display content is zoomed out.

Certainly, the user can as required define by himself/herself operations represented by respective actions and define by himself/herself operation actions, such as visual sensing correction (when the user uses a device for the first time, he/she is required to stare respectively at four corners of the display so that a camera records free distances of spatial coordinates of user's reference object within the range of the display, longitudinal/transverse maximum coordinates and a display position targeted by the user's current gaze so as to ensure accuracy of subsequent operations), display content targeting (after coordinates of a current reference object of the user is analyzed, a content targeting cursor is required to notify the user of a display position targeted by his/her current gaze, if the user considers that the analysis is not accurate, further visual sensing correction can be made until the display position targeted by the gaze is accurately sensed) and the like.

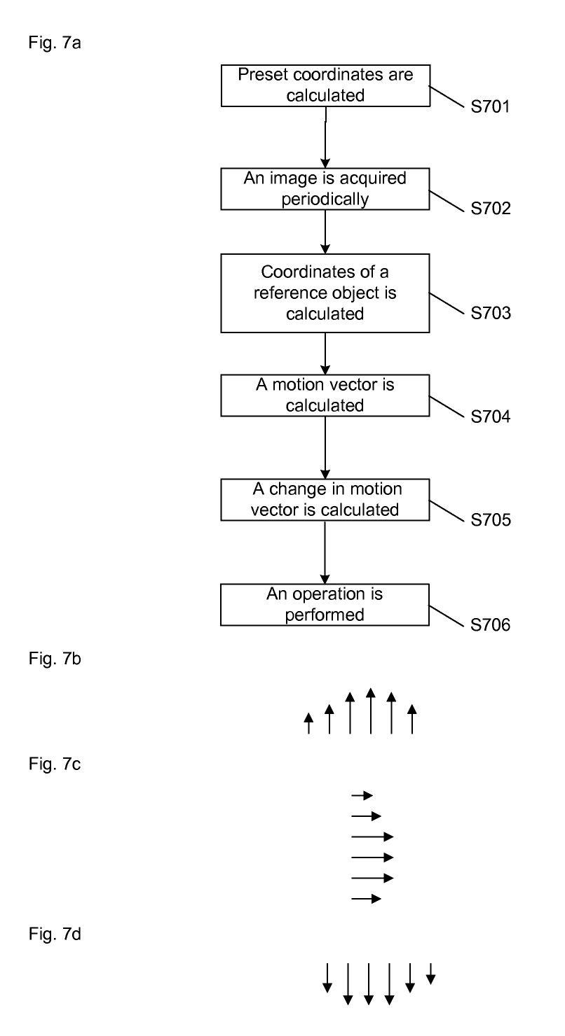

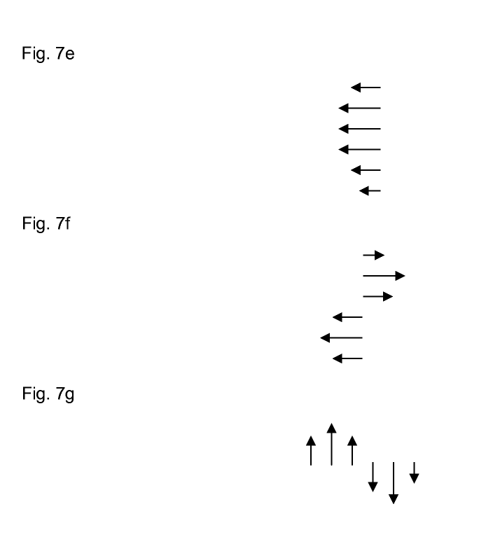

The display control method also has other implementation methods, for example the method as shown in FIG. 7a that is a flow chart of a display control method according to another embodiment of the present disclosure.

It can be seen from FIG. 7a that in an embodiment, the display control method provided by the present disclosure includes the following steps:

S701, preset coordinates are calculated and recorded, which is the same as step S601;

S702, a facial image of a user is periodically acquired, which is the same as step S602;

S703, coordinates of a reference object are calculated, which is the same as step S603;

S704, a motion vector of the reference object is determined;

the motion vector of the reference object is obtained by subtracting 255 from coordinates of the reference object calculated in step S603;

S705, a change of the motion vector of the reference object within a preset period of time is calculated;

an obtained change chart of the reference object in motion vector is as shown in FIG. 7b to FIG. 7g.

S706, an operation is performed according to the change obtained in step S705.

In the above embodiment, changes of the reference object in motion vector obtained in step S705 are shown in a change curve chart; it is assumed that the duration of the preset period of time is 6 acquisition periods; in the period of time, it is assumed that curve charts of the changes of the reference object in motion vector are shown respectively in FIG. 7b to FIG. 7g (sizes and directions of arrows in the figures represent motion vectors of the reference object in six facial images in relation to preset coordinates), wherein

the change in motion vector as shown in FIG. 7b represents looking upwards (i.e., moving upwards or paging up);

the change in motion vector as shown in FIG. 7c represents right shift (i.e., moving right or paging right);

the change in motion vector as shown in FIG. 7d represents looking downwards (i.e., moving downwards or paging down);

the change in motion vector as shown in FIG. 7e represents left shift (i.e., moving left or paging left);

the change in motion vector as shown in FIG. 7f represents head shaking (i.e., cancellation or negation operation);

the change in motion vector as shown in FIG. 7g represents nodding (i.e., confirmation or affirmation operation);

In the embodiment, only cases in which the reference object moves on a plane parallel to the display plane are provided, in other embodiments, the reference object may also move on planes perpendicular to the display plane, then 3D coordinates can be used to calculate spatial positions of the reference object and change of the reference object in spatial position, for example the X axis represents a direction from left to right, the Y axis represents a direction from up to bottom ad the Z axis represents a direction from front to back; when the object moves in the Z axis direction, a decrease in Z-axis coordinates represents that the reference object is approaching the display, then the display content is zoomed in , otherwise, the display content is zoomed out.

The above two embodiments are only preferred methods for acquiring changes of the reference object in position, other methods can certainly be used to acquire changes of the reference object in position, for example an image comparison method (i.e., superimposing and comparing two images captured with a same size).

Compared with the prior art, embodiments of the present disclosure have the following improvements:

firstly, the technique performs display control based on facial images of a user, it is more convenient than existing control techniques through key buttons, touch screen, mouse or even gestures, thus freeing thoroughly both hands of the user;

secondly, the technique performs display control based on relative coordinates of a reference object on the user's face, and the user can set as required the reference object, for example any one pupil, apex of nose or even a marking point on the face can be acceptable, thus making it possible to provide the user with diversified individualized selections;

next, the operation principle of the technique is simple, the display of the terminal can be controlled only according to changes of the reference object in spatial position or in motion vector, thus it has low requirements on the terminal's hardwares so that the technique can be applied widely to daily life;

finally, the technique is convenient and efficient since it can perform control based on a change of the position of the user's pupil when the user is reading;

to sum up, with the implementation of the present disclosure, the user can implement control of content displayed by a terminal using only facial actions rather than a keyboard, a mouse or a touch screen, thus enhancing user experiences.

The above are merely specific embodiments of the present disclosure, and are not intended to limit the present disclosure. Any simple changes, equivalent variations or modifications of the above embodiments based on the technical essence thereof all belong to the scope of protection of the technical solutions of the embodiments of the present disclosure.

### INDUSTRIAL APPLICABILITY

The present disclosure provides a display control method, device and terminal, wherein the display control device acquires periodically a facial image of a user through a sensing device, calculates coordinates of a reference object according to the facial image, and controls display of a display device according to the coordinates of the reference object and preset coordinates. With the implementation of the present disclosure, the user can implement control of content displayed by a terminal using only facial actions rather than a keyboard, a mouse or a touch screen, thus freeing both hands of the user and enhancing user experiences.

1. A display control method, comprising:
acquiring periodically a facial image of a user;
calculating coordinates of a reference object according to the facial image; and
processing the coordinates of the reference object and preset coordinates and performing an operation.

2. The display control method according to claim 1, wherein the reference object is any one point or multiple points in the facial image; the preset coordinates are spatial coordinates of the reference object when the user reads normally currently-displayed content.

3. The display control method according to claim 2, wherein the step of processing the coordinates of the reference object and preset coordinates and performing an operation comprise:
calculating a motion vector of the reference object according to the coordinates of the reference object and the preset coordinates;
performing the operation according to a change of the motion vector of the reference object within a preset period of time.

4. The display control method according to claim 2, wherein the step of processing the coordinates of the reference object and preset coordinates and performing an operation comprise:
determining a spatial position of the reference object according to the coordinates of the reference object and the preset coordinates;
performing the operation according to a change of the spatial position of the reference object within a preset period of time.

5. The display control method according to claim 1, wherein when the reference object is one or two center points of pupils of the user in the facial image, the step of calculating coordinates of the reference object according to the facial image comprises steps of:
acquiring an RGB component image of the facial image, and selecting a red component image;
obtaining a reverse color diagram of the red component image by subtracting 255 from component values of respective points of the red component image;
acquiring coordinates of peak values in a X axis direction and in a Y axis direction by performing accumulation on the reverse color diagram in the X axis direction and in the Y axis direction respectively; and
determining the coordinates of the reference object according to the coordinates of the peak values.

6. A display control device comprising an acquisition module, a processing module and an execution module, wherein
the acquisition module is configured to acquire periodically a facial image of a user;
the processing module is configured to calculate coordinates of a reference object according to the facial image, compare the coordinates of the reference object with preset coordinates and output a processing result to the execution module; and
the execution module is configured to execute an operation according to the processing result.

7. The display control device according to claim 6, wherein the reference object is any one point or multiple points in the facial image; the preset coordinates are spatial coordinates of the reference object when the user reads normally currently-displayed content.

8. The display control device according to claim 7, wherein the processing module comprises a first processing unit configured to calculate a motion vector of the reference object according to the coordinates of the reference object and the preset coordinates, and output a processing result according to a change of the motion vector of the reference object within a preset period of time.

9. The display control device according to claim 7, wherein the processing module comprises a second processing unit configured to calculate a spatial position of the reference object according to the coordinates of the reference object and the preset coordinates, and output a processing result according to a change of the spatial position of the reference object within a preset period of time.

10. The display control device according to claim 6, wherein the processing module comprises a calculation unit configured to, when the reference object is one or two center points of pupils of the user in the facial image, acquire an RGB component image of the facial image, select a red component image, obtain a reverse color diagram of the red component image by subtracting 255 from component values of respective points of the red component image, acquire coordinates of peak values in a X axis direction and in a Y axis direction by performing accumulation on the reverse color diagram in the X axis direction and in the Y axis direction respectively, and determine the coordinates of the reference object according to the coordinates of the peak values.

11. A display control terminal comprising a sensing device, a display device and the display control device according to claim 6, wherein the display control device is configured to acquire periodically the facial image of the user through the sensing device, calculate the coordinates of the reference object according to the facial image, and control content display of the display device according to the coordinates of the reference object and the preset coordinates.
